(19) United States
(12) Patent Application Publication
(10) Pub. No.: US 2013/0019729 A1
(43) Pub. Date: Jan. 24, 2013

(54) PRINTER CONVENIENT FOR MAINTAINING PAPER CUTTING DEVICE

(71) Applicants: Jigang Zhang, Weihai (CN); Qiangzi Cong, Weihai (CN); Tianxin Jiang, Weihai (CN); Min Yang, Weihai (CN); Chunguang Ma, Weihai (CN)

(72) Inventors: Jigang Zhang, Weihai (CN); Qiangzi Cong, Weihai (CN); Tianxin Jiang, Weihai (CN); Min Yang, Weihai (CN); Chunguang Ma, Weihai (CN)

(21) Appl. No.: 13/637,622

(22) PCT Filed: Mar. 2, 2011
(86) PCT No.: PCT/CN11/71467

§ 371 Date: Sep. 26, 2012

Related U.S. Application Data
(66) Substitute for application No. PCT/CN2011/071467, filed on Mar. 2, 2011.

(30) Foreign Application Priority Data
Mar. 26, 2010 (CN) 201010155692.9

(51) Int. Cl. B26D 7/26; B65H 35/00

(52) U.S. Cl. 83/86; 83/441

(57) ABSTRACT

The present invention discloses a printer convenient for maintaining a paper cutting device (500). The printer comprises a paper cutting device and a movable blade avoiding mechanism. The paper cutting device has a movable blade component (510) fixed on the upper cover (100) of the printer and a fixed blade (520) fixed on the body (200) of the printer, the movable blade avoiding mechanism has an avoiding cover (210) capable of turning upward and pivoted to the body of the printer, and a positioning member (240) and an elastic pressing member (230) which keep the avoiding cover in a predetermined position on the top of the fixed blade. The avoiding cover and the upper cover of the printer are respectively arranged at two sides of a printing paper conveying passage, with opposite turning directions, and the movable blade (511) of the movable blade component is located between the avoiding cover and the fixed blade. When paper is jammed during the use of the printer, the avoiding cover of the movable blade avoiding mechanism is turned by the action of the movable blade or turns automatically, so that a problem can be avoided that the upper cover of the printer cannot be opened until the movable blade is reset to the initial position by hands. Furthermore, the structure of the movable blade avoiding mechanism is simple, and thus the overall cost of the printer is reduced.

The application claims for the priority of Chinese patent for invention with application No. 201010155692.9, titled as “Printer Convenient for Maintaining Paper Cutting Device”, and submitted on Mar. 26, 2010, and all disclosed contents thereof should be incorporated herein by reference.

### TECHNICAL FIELD OF THE INVENTION

The present invention relates to a printer, in particular to a printer convenient for maintaining a paper cutting device.

### BACKGROUND OF THE INVENTION

Printers are increasingly applied in fields such as supermarket, lottery sales and restaurant. In order to improve the working efficiency, some printers are also provided with a paper cutting device that can cut paper automatically, and such paper cutting device is usually called a cutter.

The common paper cutting device comprises a fixed blade and a movable blade, the fixed blade and the movable blade are arranged oppositely and respectively mounted on the upper cover and the body of the printer. When the paper cutting device is not working, the fixed blade and the movable blade are arranged respectively at the two sides of a paper feeding passage, and the printing paper passes between the fixed blade and the movable blade. When the paper cutting device is working, the driving mechanism of the paper cutting device drives the movable blade to move relatively to the fixed blade. As the movable blade is located above the fixed blade, when the movable blade gets close to the fixed blade and the movable blade and the fixed blade are gradually overlapped, the printing paper is cut off.

In a common printer, the fixed blade of the paper cutting device is fixed on the upper cover, and is opened relatively to the movable blade as the upper cover is opened. Such structure has one defect that, when the cutter is jammed with paper, the movable blade is above the fixed blade and may be unable to return to the initial position. As a result, the upper cover of the printer cannot be opened until the movable blade is reset to the initial position by hands, and the maintenance is very complicated.

To solve this problem, American invention U.S. Pat. No. 6,508,600 proposed a solution. The fixed blade of the cutter is arranged on the body of the printer, and the movable blade is arranged on the upper cover of the printer above the fixed blade and is opened as the upper cover of the printer is opened.

When the upper cover is closed with respect to the body, by snapping a hook on the upper cover of the printer with a hook on the fixed blade cover and by locking the other hook on the fixed blade cover with the hook on the body of the printer, the rotation of the fixed blade cover is limited, thus the upper cover of the printer is locked.

If the upper cover of the printer needs to be opened, the fixed blade cover needs to be pulled along one direction to unlock the two pairs of locking mechanisms, and the fixed blade cover drives a ejector rod to eject the upper cover of the printer. At this time, no matter whether the movable blade is in the normal non-stretched state or in the abnormal stretched state, the upper cover of the printer can be opened freely, and the problem that the movable blade has to be reset by hands when the movable blade cannot be reset to the initial position due to jamming of paper is solved.

However, the structure in the above solution is very complicated, many parts are required, the maintenance is inconvenient, and the cost is relatively high.

### SUMMARY OF THE INVENTION

The purpose of the present invention is to provide a printer convenient for maintaining a paper cutting device, with simple structure, convenient and simple operation and low cost.

Therefore, the present invention provides a printer convenient for maintaining a paper cutting device, comprising: a paper cutting device, a movable blade component thereof being fixed on the upper cover of the printer and a fixed blade thereof fixed on the body of the printer; and a movable blade avoiding mechanism, comprising: an avoiding cover capable of turning upward and pivoted to the body of the printer, a positioning member and an elastic pressing member which keep the avoiding cover in a predetermined position on the top of the fixed blade, wherein the avoiding cover and the upper cover of the printer are respectively arranged at two sides of a printing paper conveying passage, with opposite turning directions, and the movable blade of the movable blade component is located between the avoiding cover and the fixed blade.

Further, one end face of the avoiding cover is opposite to one end face of the upper cover of the printer in the predetermined position, and a passage connected with the paper outlet is formed between the two end faces.

Further, the positioning member is arranged below the avoiding cover.

Further, the avoiding cover comprises a cover body and a mounting portion extending downward from the cover body, wherein the mounting portion is pivoted with the body of the printer via a pivoting shaft.

Further, the side of the positioning member facing the movable blade component forms a movable blade guide edge.

Further, the printer further comprising a paper stacking component, wherein the paper stacking component comprising: a paper stacking cabin fixed on the upper cover of the printer and a paper stacking cover that is arranged on the body of the printer in a turnover manner and that forms a paper stacking space with the paper stacking cabin, wherein the positioning member is the paper stacking cabin arranged above the avoiding cover.

Further, the paper stacking component further comprising: a paper guide roller component comprising a first paper guide roller supported on the paper stacking cover, a second paper guide roller supported on the paper stacking cabin and contacted with the first paper guide roller, and a driving mechanism of the second paper guide roller.

Further, the avoiding cover has a cover body and a mounting portion that is located at the upper part or lower part of the cover body and pivoted with the body of the printer via a pivoting shaft.

Further, the mounting portion of the avoiding cover is located at the lower part of the cover body, the avoiding cover also has a stop portion located below the cover body and a positioning portion located above the cover body, wherein the stop portion is elastically contacted with the free end of the elastic pressing element, and the positioning portion fits a positioning face at the lower end of the paper stacking cover for positioning.

Further, the side of the avoiding cover facing the movable blade component forms a guide edge contacted with the printing paper.

In the present invention, when paper is jammed during the use of the printer, the avoiding cover of the movable blade avoiding mechanism is turned by the action of the movable blade or turns automatically, so that the problem can be avoided that the upper cover of the printer cannot be opened until the movable blade is reset to the initial position by hands. Furthermore, the structure of the movable blade avoiding mechanism is simple, and thus the overall cost of the printer is reduced.

Besides purposes, features and advantages described above, the present invention also has other purposes, features and advantages. Other purposes, features and advantages of the present invention will be further described in details below As shown in drawings.

### BRIEF DESCRIPTION OF THE DRAWINGS

Drawings, which form a part of the description and are provided for further understanding of the present invention, show the preferred embodiments of the present invention, and explain the principle of the present invention together with the description. In the drawings:

FIG. 1 is a structure profile diagram of a printer according to the first embodiment of the present invention when the upper cover is closed;

FIG. 2 is a drawing of partial enlargement of a printer according to the first embodiment of the present invention when the cutter is in the initial position;

FIG. 3 is a drawing of partial enlargement of a printer according to the first embodiment of the present invention when the cutter is in the cutting position;

FIG. 4 is a drawing of partial enlargement of a printer with open upper cover according to the first embodiment of the present invention when the cutter works normally;

FIG. 5 is a drawing of partial enlargement of a printer with open upper cover according to the first embodiment of the present invention when the cutter works abnormally and the movable blade cannot be reset;

FIG. 6 is a structure diagram of a printer according to the second embodiment of the present invention when the cutter works normally;

FIG. 7 is a drawing of partial enlargement of the printer of FIG. 6; and

FIG. 8 is a drawing of partial enlargement of a printer with open upper cover according to the second embodiment of the present invention when the cutter works abnormally and the movable blade cannot be reset.

### DETAILED DESCRIPTION OF THE EMBODIMENTS

The embodiments of the present invention will be described in detail below As shown in drawings, however the present invention may be implemented by various different ways defined and covered by the claims. In the drawings, identical components are indicated by identical reference number.

The first embodiment is described as follows:

In the embodiment, the movable blade of the paper cutting device is put on the upper cover of the printer and can be opened as the upper cover of the printer is opened, and a movable blade avoiding mechanism is arranged above the fixed blade of the paper cutting device. When the movable blade cannot be reset to the initial position due to fault, during the process of opening the upper cover of the printer, the stretched movable blade drives the avoiding cover of the movable blade avoiding mechanism to move, so that the upper cover of the printer can be opened smoothly.

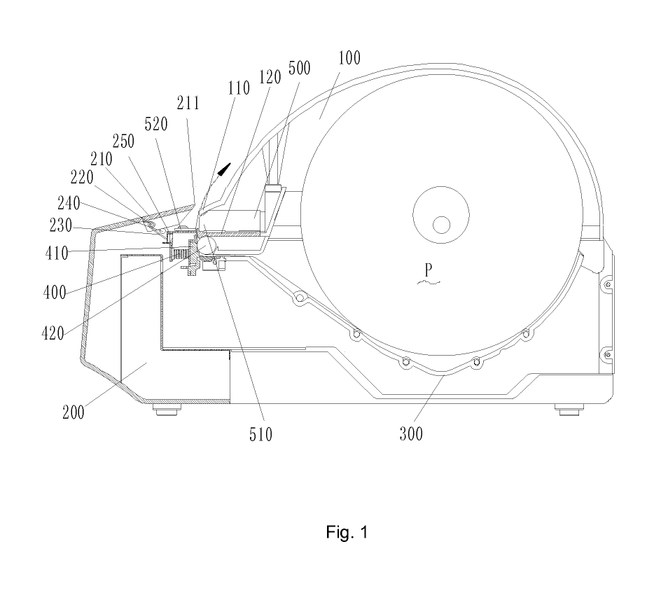

FIG. 1 to FIG. 5 illustrate the structure of a printer convenient for maintaining a paper cutting device according to the first embodiment of the present invention. As shown in FIG. 1 to FIG. 5, the upper cover 100 of the printer is hinged to the body (lower shell) 200 of the printer, and can be opened and closed with respect to the body 200 of the printer. Inside a space formed by the upper cover 100 and the body 200 of the printer, a paper containing component 300 is provided to contain the printing paper P.

In the conveying direction of the printing paper P, a printing component 400 is arranged in the downstream of the paper containing component 300 to be used for printing the preset printing contents on the printing paper P. The printing component 400 may be a thermal printing component, and it also may be a dot-matrix, inkjet or laser printing component.

In the embodiment, the printing component 400 is a thermal printing component comprising a print head 410 and a printing rubber roller 420, wherein the print head 410 is fixed on the body 200 of the printer, and the printing rubber roller 420 is fixed on the upper cover 100. When the upper cover 100 of the printer is closed with respect to the body 200 of the printer, the print head 400 is tangent to the printing rubber roller 420, the printing rubber roller 420 rotates under the drive of the transmission system to drive paper between the print head 410 and the printing rubber roller 420 to move to the downstream of the printing component 400. Simultaneously, the print head 410 prints on the printing paper.

As the arrangement form of dot-matrix, inkjet and laser printing components is well known by those skilled in the field, it will not be described again here.

A paper cutting device 500 is arranged in the downstream of the printing component 400 to cut the printed paper. The paper cutting device 500 comprises a movable blade component 510 and a fixed blade 520.

The movable blade component 510 is fixed on a movable blade support rack 120, which is one part of the upper cover 100 of the printer, and the movable blade support rack 120 is located in the downstream of the printing rubber roller 420 in the paper discharge direction. The fixed blade 520 is fixed on a fixed blade support rack 250, which is one part of the body 200 of the printer, and the fixed blade support rack 250 is located in the downstream of the print head 410 in the paper discharge direction.

When the upper cover 100 of the printer is closed, the movable blade 511 on the movable blade component 510 and the fixed blade 520 are opposite in the transverse direction, and in the paper discharge direction, the movable blade 511 is located in the downstream of the fixed blade 520, and the printing paper P passes between the movable blade 511 and the fixed blade 520.

The movable blade avoiding mechanism comprises an avoiding cover 210, a positioning member 240 and an elastic pressing member 230 which keep the avoiding cover in a predetermined position at the top of the fixed blade 520.

The avoiding cover 210 is arranged in the downstream of the paper cutting device 500, located above the fixed blade 520, is opposite to the tail end 110 of the upper cover, and forms a paper outlet from which the cut printing paper is discharged.

The avoiding cover 210 is hinged to the body 200 of the printer via a rotating shaft (i.e., pivoting shaft) on the body 200 of the printer and can rotate relatively. Simultaneously, the avoiding cover 210 always keep in a trend to cover the fixed blade 520 under the effect of the elastic pressing element 230 on the body 200 of the printer.

The positioning member 240 on the body 200 of the printer is used for limiting the initial position of the avoiding cover 210. In the initial position of the avoiding cover 210, the tail end of the avoiding cover 210 is opposite to the tail end 110 of the upper cover 100 of the printer to form a paper outlet.

Under the drive of the transmission system (not shown) in the printer, the printing paper P is conveyed to the printing component 400 from the paper containing component 300, images or characters are printed on the surface of paper via the printing component 400, the printed paper is cut by the paper cutting device 500, and the cut paper is discharged out of the printer from the paper outlet.

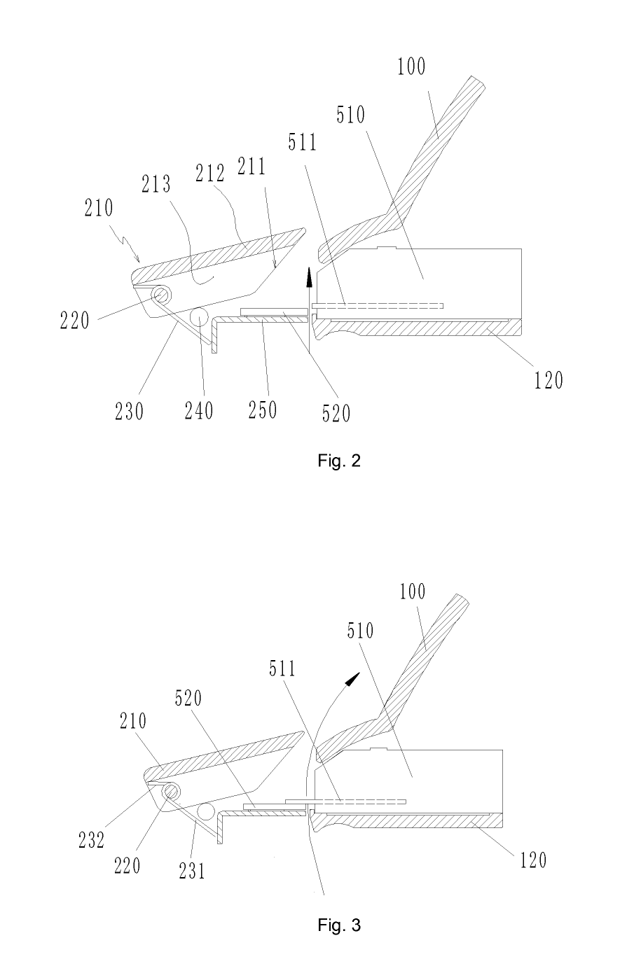

FIG. 2 is a drawing of partial enlargement of a printer according to the first embodiment of the present invention when the cutter is in the initial position, and FIG. 3 is a drawing of partial enlargement of a printer according to the first embodiment of the present invention when the cutter is in the cutting position.

As shown in FIG. 2, the avoiding cover 210 comprises a cover body 212 and a mounting portion 213 extending downward from the cover body 212, and the mounting portion 213 is pivoted (or called hinged) with the body 200 of the printer via a pivoting shaft 220.

The fixed end 231 of the elastic pressing element 230 is supported or fixed on the fixed blade support rack 250, the free end 232 contacts against the bottom side face of the cover body 212 of the avoiding cover 210 to stress elasticity on the avoiding cover 210. Besides, the positioning member 240 is arranged below the mounting portion 213 of the avoiding cover 210, and the positioning member 240 is used for limiting the initial position of the avoiding cover 210.

The front side of the mounting portion 213 of the avoiding cover 210 forms a movable blade guide edge 211 contacted with the movable blade 511 of the movable blade component 510.

In FIG. 2, the avoiding cover 210 is in the initial position or start position, the movable blade 511 and the fixed blade 520 are opposite in the transverse direction, and the movable blade 511 is in retracted positions, and the printing paper P passes between the movable blade 511 and the fixed blade 520.

As shown in FIG. 3, when the printer sends a cutting paper command, under the drive of a cutter driving system (not shown), the movable blade 511 transversely moves towards the fixed blade 520, when the movable blade 511 and the fixed blade 520 are overlapped, the paper is cut, the cutting paper action is completed; the cutter driving system continuously drives, the movable blade 511 gets back to the initial position to complete reset and get ready for the next cutting paper action.

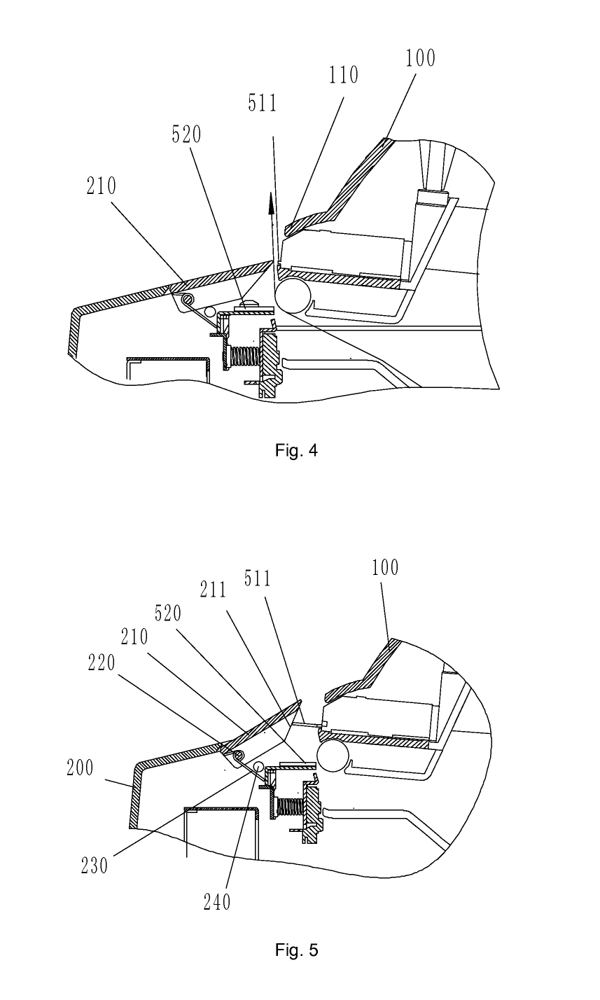

FIG. 4 is a drawing of partial enlargement of a printer with open upper cover according to the first embodiment of the present invention when the cutter works normally. As shown in FIG. 4, at this time, the movable blade 511 is in the initial position, during the process of opening the upper cover 100 of the printer, there is no any obstacle, and the upper cover 100 is opened directly to execute operations such as replacement of a paper roll.

FIG. 5 is a drawing of partial enlargement of a printer with open upper cover according to the first embodiment of the present invention when the cutter works abnormally and the movable blade cannot be reset. As shown in FIG. 5, at this time, the movable blade 511 cannot be reset to the initial position due to causes such as jamming of paper, the movable blade 511 stretches outside the movable blade component 510, during the process of opening the upper cover 100 of the printer, the movable blade 511 ejects the avoiding cover along the guide edge 211 of the avoiding cover 210 to make the avoiding cover 210 rotate counterclockwise to turn upward, when the upper cover 100 of the printer is opened, the avoiding cover 210 rotates clockwise under the effect of the elastic pressing element 230 to be contacted with the positioning member 240, and gets back to the initial position.

A second embodiment is described as follows:

In the embodiment, when the movable blade cannot be reset due to faults, during the process of opening the paper stacking cover, the avoiding cover of the movable blade avoiding mechanism automatically opens under the effect of the elastic pressing element, so that the upper cover of the printer with the stretched movable blade can be opened smoothly.

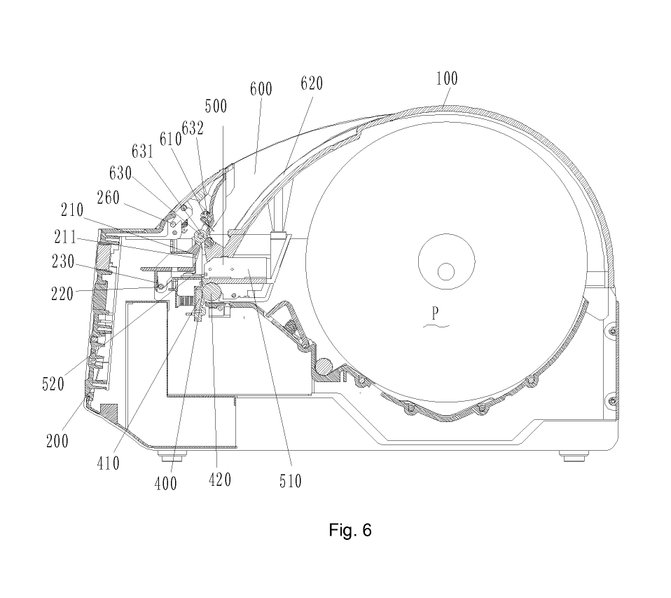

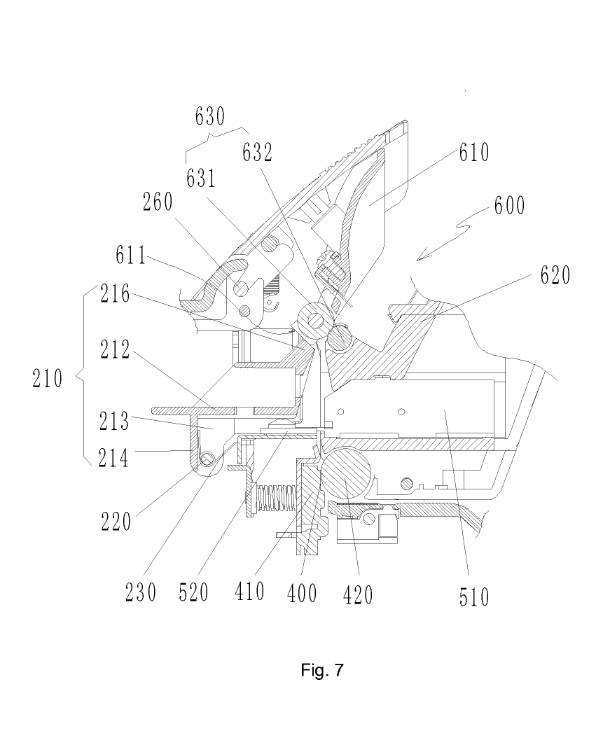

FIG. 6 is a structure diagram of a printer according to the second embodiment of the present invention when the cutter works normally, and FIG. 7 is a drawing of partial enlargement of the printer of FIG. 6. As shown in FIG. 6 and FIG. 7, the difference between the embodiment and the first embodiment is that, a paper stacking component 600 is arranged in the downstream of the avoiding cover 210 in the conveying direction of the printing paper P for stacking the cut paper.

The paper stacking component 600 is located in the downstream of the avoiding cover 210 and comprises: a paper stacking cover 610, a paper stacking cabin 620, a paper guide roller component 630 and a driving system (not shown) of the paper guide roller component 630.

Wherein, the paper stacking cover 610 is hinged to the body 200 of the printer via a turnover rotating shaft 260 on the body 200 of the printer, and can be opened and closed relatively.

The paper stacking cabin 620 is arranged on the upper cover 100, when the paper stacking cover 610 is closed, the paper stacking cabin 620 is opposite to the paper stacking cover 610 to form a paper stacking space for containing the cut paper.

The paper guide roller component 630 comprises a first paper guide roller 631 and a second paper guide roller 632, the first paper guide roller 631 is hinged to the paper stacking cover 610, the second paper guide roller 632 is hinged to the paper stacking cabin 620, when the paper stacking cover is closed, the first paper guide roller 631 is tangent to the second paper guide roller 632. Driven by the driving system, the second paper guide roller 632 rotates to convey the cut paper to the paper stacking cabin 620.

In the embodiment, the avoiding cover 210 comprises: a cover body 212, extending on the top of the fixed blade 520; a mounting portion 213, extending downward from the cover body 212 and being hinged to the body 200 of the printer via the pivoting shaft 220; a stop portion 214, extending downward from the cover body 212 and being vertical to the mounting portion 213; and a positioning portion 216, extending upward from the cover body 212 and fitting the positioning face 611 at the lower end of the paper stacking cover 610 for positioning. The paper stacking cover 610 forms the positioning member of the avoiding cover 210.

The side of the avoiding cover facing the movable blade component 510 forms a guide edge 211 contacted with the printing paper, to guide the conveying of the printing paper in the printing paper conveying passage.

The elastic pressing element 230 is a torsion spring sleeved on the pivoting shaft 220 of the mounting portion 213, the free end 232 of the torsion spring contacts against the stop portion 214 of the avoiding cover. When the paper stacking cover 610 is opened, the positioning face 611 at the lower end of the paper stacking cover 610 is separated from the avoiding cover 210, at this time, the avoiding cover 210 can open automatically under the elasticity of the elastic pressing element 230, so that the upper cover of the printer with the stretched blade can be opened smoothly.

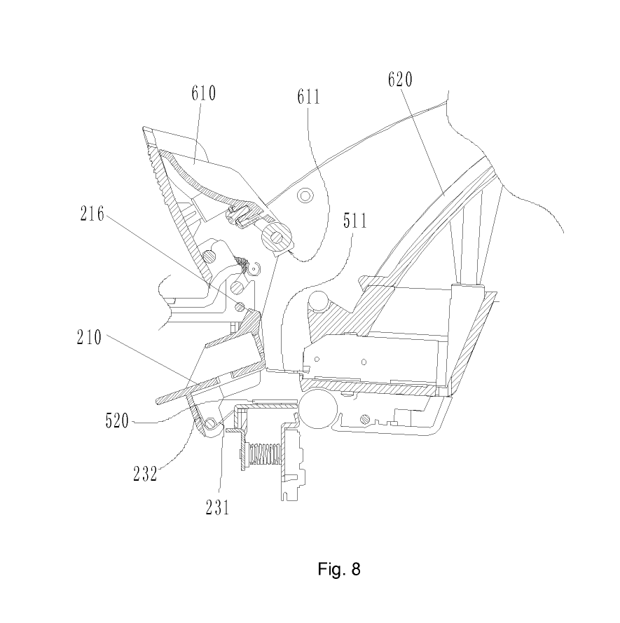

FIG. 8 is a drawing of partial enlargement of a printer with open upper cover according to the second embodiment of the present invention when the cutter works abnormally and the movable blade cannot be reset. As shown in FIG. 8, when the cutter is in fault and the movable blade 511 cannot return into the movable blade component 510, first, the paper stacking cover 610 is opened, during the process of opening the paper stacking cover, the avoiding cover 210 pops up automatically under the effect of the elastic pressing element to avoid interfering the movable blade 520 along with the turnover motion of the upper cover of the printer.

Of course, the structure of the movable blade avoiding mechanism in the first embodiment also may be employed. That is, during the process of opening the upper cover 100 of the printer, the movable blade 511 ejects the avoiding cover 210 along the guide edge 211 of the avoiding cover 210 to make the avoiding cover 210 rotate counterclockwise to turn over, after the upper cover 100 of the printer is opened, the avoiding cover 210 rotates clockwise under the effect of the elastic pressing element 230, and resets to the initial position.

From the above description, it can be seen that, in the present invention, when paper is jammed during the use of the printer, as the movable blade of the cutter is at the outer side of the fixed blade of the cutter, the movable blade of the cutter can be opened together with the upper cover of the printer. Simultaneously, the avoiding cover to which the movable blade of the cutter will contact is designed as a turnover part, during the turning and opening process, the avoiding cover automatically turns or ejected directly by the movable blade, the problem is avoided that the upper cover of the printer can be opened only after the movable blade of the cutter is reset to the initial position by hands. Simultaneously, as it is just needed to design the avoiding cover into a turnover part, the structure is simple and thus the cost is reduced.

Above contents only describe the preferred embodiments of the present invention and are not intended to limit the present invention; for one skilled in the art, the present invention may have various modifications and changes. Any modifications, equivalent replacements and improvements made within the spirit and principle of the present invention should be included within the protection scope of the present invention.

1. A printer convenient for maintaining a paper cutting device, comprising: a paper cutting device, a movable blade component thereof fixed on the upper cover of the printer and a fixed blade thereof fixed on the body of the printer, further comprising:
a movable blade avoiding mechanism, comprising: an avoiding cover capable of turning upward and pivoted to the body of the printer, a positioning member and an elastic pressing member which keep the avoiding cover in a predetermined position on the top of the fixed blade,
wherein, the avoiding cover and the upper cover of the printer are respectively arranged at two sides of a printing paper conveying passage with opposite turning directions, and a movable blade of the movable blade component is located between the avoiding cover and the fixed blade.

2. The printer convenient for maintaining a paper cutting device according to claim 1, wherein one end face of the avoiding cover is opposite to one end face of the upper cover of the printer in the predetermined position, and a passage connected with the paper outlet is formed between the two end faces.

3. The printer convenient for maintaining a paper cutting device according to claim 2, wherein the positioning member is arranged below the avoiding cover.

4. The printer convenient for maintaining a paper cutting device according to claim 3, wherein the avoiding cover comprises a cover body and a mounting portion extending downward from the cover body, wherein the mounting portion is pivoted with the body of the printer via a pivoting shaft.

5. The printer convenient for maintaining a paper cutting device according to claim 4, wherein a side of the avoiding cover facing the movable blade component forms a movable blade guide edge.

6. The printer convenient for maintaining a paper cutting device according to claim 1, wherein the positioning member is the fixed blade or a fixed blade support rack.

7. The printer convenient for maintaining a paper cutting device according to claim 1, further comprising a paper stacking component, wherein the paper stacking component comprising: a paper stacking cabin fixed on the upper cover of the printer and a paper stacking cover that is arranged on the body of the printer in a turnover manner and forms a paper stacking space with the paper stacking cabin, wherein the positioning member is the paper stacking cover arranged above the avoiding cover.

8. The printer convenient for maintaining a paper cutting device according to claim 7, wherein the avoiding cover has a cover body and a mounting portion that is located at the upper part or lower part of the cover body and pivoted with the body of the printer via a pivoting shaft.

9. The printer convenient for maintaining a paper cutting device according to claim 8, wherein the mounting portion of the avoiding cover is located at the lower part of the cover body, the avoiding cover has a stop portion located below the cover body and a positioning portion located above the cover body, wherein the stop portion is elastically contacted with the free end of the elastic pressing element, and the positioning portion fits a positioning face at the lower end of the paper stacking cover for positioning.

10. The printer convenient for maintaining a paper cutting device according to claim 9, wherein a side of the avoiding cover facing the movable blade component forms a guide edge contacted with the printing paper.
